(19) United States
(12) Patent Application Publication
(10) Pub. No.: US 2023/0101203 A1
(43) Pub. Date: Mar. 30, 2023

(54) ELECTROMAGNETIC RELAY

(71) Applicant: OMRON Corporation, Kyoto-shi, Kyoto (JP)

(72) Inventors: Ryota MINOWA, Kyoto-shi, Kyoto (JP); Naoki KAWAGUCHI, Kyoto-shi, Kyoto (JP); Kohei OTSUKA, Kyoto-shi, Kyoto (JP)

(21) Appl. No.: 17/800,533

(22) PCT Filed: Jan. 18, 2021
(86) PCT No.: PCT/JP2021/001411

§ 371 Date: Aug. 18, 2022

(30) Foreign Application Priority Data
Mar. 11, 2020 (JP) 2020-042427

(51) Int. Cl. H01H 50/38; H01H 50/02; H01H 50/54

(52) U.S. Cl. CPC H01H 50/38; H01H 50/02; H01H 50/54

(57) ABSTRACT

An electromagnetic relay includes a housing, a fixed contact, a fixed terminal, and a movable contact. The fixed contact and the movable contact are disposed in the housing. The movable contact faces the fixed contact. The fixed contact is connected to the fixed terminal. The fixed terminal includes a contact support portion, a first arc guide, and a second arc guide. The contact support portion supports the fixed contact. The first arc guide extends from the contact support portion. The first arc guide includes a tip that projects outward of the housing. The second arc guide extends from the contact support portion. The second arc guide includes a tip that projects outward of the housing. The first arc guide and the second arc guide are disposed in the housing to extend the arc generated at the fixed contact.

### CROSS-REFERENCE TO RELATED APPLICATION

This application is the U.S. National Phase of International Application No. PCT/JP2021/001411, filed on Jan. 18, 2021. This application claims priority to Japanese Patent Application No. 2020-042427, filed Mar. 11, 2020. The contents of those applications are incorporated by reference herein in their entireties.

### FIELD

The present invention relates to an electromagnetic relay.

### BACKGROUND

In an electromagnetic relay, an arc may occur between contacts. In that case, the arc shortens the mechanical life of the electromagnetic relay. Therefore, for example, the electromagnetic relay disclosed in Japan Laid-open Patent Application Publication No. 2012-256451 includes an arc guide (arc runner). The arc guide is connected to a movable contact piece and extends away from the fixed terminal. The arc generated between the contacts is quickly extinguished by extending along the arc guide.

### SUMMARY

In the above electromagnetic relay, the arc guide is used only for arc extension. On the other hand, in an electromagnetic relay, when a high-capacity current is applied, the terminal may generate heat and become hot. In that case, the substrate or the electromagnetic relay itself may be damaged by the heat from the terminal. An object of the present disclosure is to quickly extinguish an arc and reduce heat generation at a terminal in an electromagnetic relay.

An electromagnetic relay according to one aspect of the present disclosure includes a housing, a fixed contact, a fixed terminal, and a movable contact. The fixed contact is disposed in the housing. The movable contact is disposed in the housing and faces the fixed contact. The fixed contact is connected to the fixed terminal. The fixed terminal includes a contact support portion, a first arc guide, and a second arc guide. The contact support portion supports the fixed contact. The first arc guide extends from the contact support portion. The first arc guide includes a tip that projects outward of the housing. The first arc guide is disposed in the housing to extend an arc generated at the fixed contact. The second arc guide extends from the contact support portion. The second arc guide includes a tip that projects outward of the housing. The second arc guide is disposed in the housing to extend the arc generated at the fixed contact.

In the electromagnetic relay according to the present embodiment, the arc generated at the contact is extended along the first arc guide or the second arc guide. Thereby, the arc can be extinguished quickly. Further, the tips of the first arc guide and the second arc guide project outward from the housing and are used as external terminals. Therefore, the current flows separately in the first arc guide and the second arc guide. Thereby, heat generation in each of the first arc guide and the second arc guide can be reduced. Further, the heat generated at the contact can be transmitted to the outside of the electromagnetic relay via a plurality of paths.

The electromagnetic relay may further include a magnet. The magnet may be disposed so that a starting point of the arc generated at the fixed contact is moved at least in a predetermined direction by a magnetic force. The first arc guide may be connected to the contact support portion at a position in the predetermined direction with respect to the fixed contact. The second arc guide may be connected to the contact support portion at a position in an opposite direction to the predetermined direction with respect to the fixed contact. In this case, the arc can be effectively extended by the first arc guide or the second arc guide.

The starting point of the arc generated at the fixed contact may be moved at least in a predetermined direction by a self-magnetic field generated from the current flowing through the fixed contact. The first arc guide may be connected to the contact support portion at a position in the predetermined direction with respect to the fixed contact. The second arc guide may be connected to the contact support portion at a position in an opposite direction to the predetermined direction with respect to the fixed contact. In this case, the arc can be effectively extended by the first arc guide or the second arc guide.

The fixed terminal may have a bent shape between the first arc guide and the contact support portion. The fixed terminal may have a bent shape between the second arc guide and the contact support portion.

The fixed contact may be joined to the contact support portion by fused bonding. In this case, even if the first arc guide and the second arc guide are disposed near the contacts, the fixed contact can be easily joined to the contact support portion. Alternatively, the fixed contact may be joined to the contact support portion by caulking.

The first arc guide and the second arc guide may be joined to each other at least outside of the housing. In this case, the first arc guide and the second arc guide can be easily attached to an external electronic circuit such as a substrate.

The first arc guide and the second arc guide may be disposed to be inclined so that a distance between the first arc guide and the second arc guide increases toward a direction away from the fixed contact. In this case, the movement of the starting point of the arc can be controlled by the inclination of the first arc guide and the second arc guide.

The first arc guide and the second arc guide may be disposed to be inclined so that a distance between the first arc guide and the second arc guide becomes smaller toward a direction away from the fixed contact. In this case, the movement of the starting point of the arc can be controlled by the inclination of the first arc guide and the second arc guide.

The first arc guide may include a step portion disposed in the housing. In this case, the movement of the starting point of the arc can be restricted by the step portion. Thereby, it is possible to prevent the arc from leaking to the outside of the housing along the first arc guide.

### BRIEF DESCRIPTION OF THE DRAWINGS

FIG. 1 is a front sectional view of an electromagnetic relay according to an embodiment.

FIG. 2 is a sectional view taken along line II-II in FIG. 1.

FIG. 3 is a side view of a first fixed terminal and a movable contact piece.

FIG. 4 is a side view of the first fixed terminal and the movable contact piece according to a first modification.

FIG. 5 is a top view of a contact device according to a second modification.

FIG. 6 is a top view of the contact device according to a third modification.

FIG. 7 is a side view of the first fixed terminal and the movable contact piece according to a fourth modification.

FIG. 8 is a side view of the first fixed terminal and the movable contact piece according to a fifth modification.

FIG. 9 is a side view of the first fixed terminal and the movable contact piece according to a sixth modification.

FIG. 10 is a side view of the first fixed terminal and the movable contact piece according to a seventh modification.

FIG. 11 is a side view of the first fixed terminal and the movable contact piece according to an eighth modification.

FIG. 12 is a side view of the first fixed terminal and the movable contact piece according to a ninth modification.

FIG. 13 is a side view of the first fixed terminal and the movable contact piece according to a tenth modification.

FIG. 14 is a side view of the first fixed terminal and the movable contact piece according to an eleventh modification.

FIG. 15 is a perspective view of the first fixed terminal according to a twelfth modification.

FIG. 16 is a perspective view of the first fixed terminal according to a thirteenth modification.

FIG. 17 is a perspective view of a part of the electromagnetic relay according to a fourteenth modification.

FIG. 18 is a front sectional view showing a part of the electromagnetic relay according to a fifteenth modification.

FIG. 19 is a front view showing a part of the electromagnetic relay according to a sixteenth modification.

FIG. 20 is a top view of the contact device according to a seventeenth modification.

FIG. 21 is a top view of the contact device according to an eighteenth modification.

### DETAILED DESCRIPTION

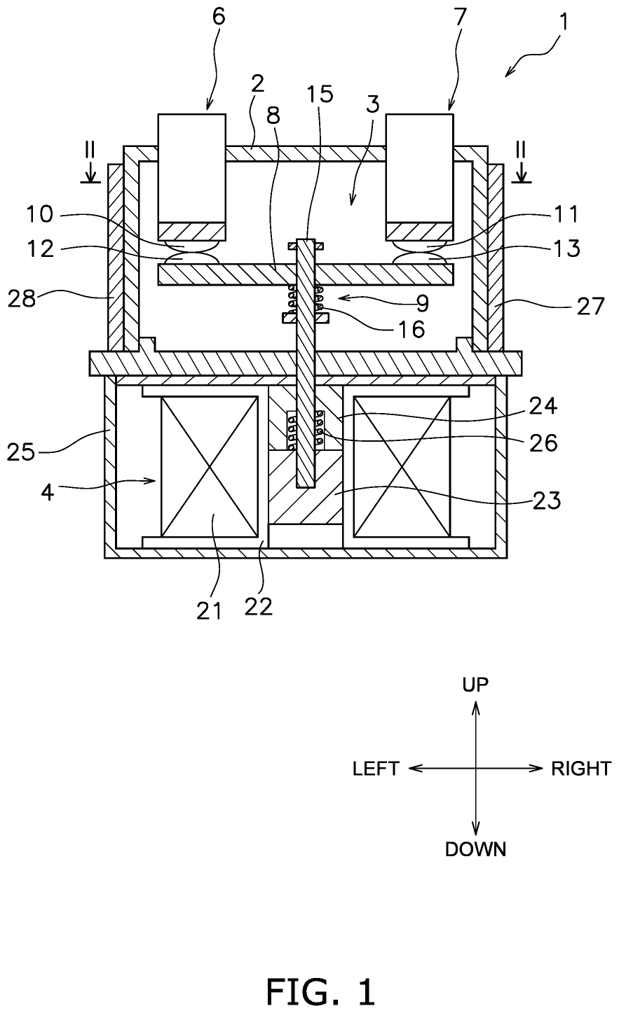

Hereinafter, an embodiment of an electromagnetic relay 1 according to one aspect of the present invention will be described with reference to the drawings. FIG. 1 is a front sectional view of the electromagnetic relay 1. As illustrated in FIG. 1, the electromagnetic relay 1 includes a housing 2, a contact device 3, and a drive device 4.

When referring to the drawings, the upper side in FIG. 1 is referred to as “upper”, the lower side is referred to as “lower”, the left side is referred to as “left”, and the right side is referred to as “right” in order to make the explanation easier to understand. Further, the front side of the paper in FIG. 1 will be described as “front” and the back side will be described as “rear”. However, these directions are defined for convenience of explanation, and do not limit the arrangement direction of the electromagnetic relay 1.

The housing 2 is made of an insulating material such as resin. However, the housing 2 may be made of another material such as ceramic. The contact device 3 is housed in the housing 2.

The contact device 3 includes a first fixed terminal 6, a second fixed terminal 7, a movable contact piece 8, and a movable mechanism 9. The first fixed terminal 6 and the second fixed terminal 7 extend in the moving direction of the movable contact piece 8. The first fixed terminal 6 and the second fixed terminal 7 are disposed so as to be spaced apart from each other in the left-right direction. A first fixed contact 10 is connected to the first fixed terminal 6. A second fixed contact 11 is connected to the second fixed terminal 7. The first fixed contact 10 and the second fixed contact 11 are disposed in the housing 2.

The movable contact piece 8 extends in the left-right direction. The movable contact piece 8 is disposed in the housing 2. A first movable contact 12 and a second movable contact 13 are connected to the movable contact piece 8. The first movable contact 12 faces the first fixed contact 10. The second movable contact 13 faces the second fixed contact 11. The first movable contact 12 is disposed at a distance from the second movable contact 13 in the left-right direction.

The movable contact piece 8 is movable in a contact direction and an opening direction. The contact direction is a direction in which the movable contacts 12 and 13 approach the fixed contacts 10 and 11. The opening direction is a direction in which the movable contacts 12 and 13 are separated from the fixed contacts 10 and 11. In the present embodiment, the movable contact piece 8 is movable in the vertical direction.

The movable mechanism 9 supports the movable contact piece 8. The movable mechanism 9 is configured to move between a closed position and an open position. When the movable mechanism 9 is in the closed position, the fixed contacts 10 and 11 and the movable contacts 12 and 13 contact each other. When the movable mechanism 9 is in the open position, the fixed contacts 10 and 11 and the movable contacts 12 and 13 are separated from each other. The movable mechanism 9 includes a drive shaft 15 and a contact spring 16. The drive shaft 15 is connected to the movable contact piece 8. The drive shaft 15 extends in the vertical direction and extends through the movable contact piece 8 in the vertical direction. The drive shaft 15 is configured to move in the vertical direction. The contact spring 16 urges the movable contact piece 8 in the contact direction.

The drive device 4 includes a coil 21, a spool 22, a movable iron core 23, a fixed iron core 24, a yoke 25, and a return spring 26. The drive device 4 moves the movable contact piece 8 in the contact direction and the opening direction via the movable mechanism 9 by an electromagnetic force. The coil 21 is wound around the spool 22. The movable iron core 23 and the fixed iron core 24 are disposed in the spool 22. The movable iron core 23 is connected to the drive shaft 15. The movable iron core 23 is movable in the vertical direction. The fixed iron core 24 is disposed so as to face the movable iron core 23. The return spring 26 urges the movable iron core 23 in the opening direction.

In the electromagnetic relay 1 according to the present embodiment, when the coil 21 is energized, the movable iron core 23 is attracted to the fixed iron core 24 by the magnetic force generated by the magnetic field generated from the coil 21. As a result, the movable iron core 23 and the drive shaft 15 move in the contact direction against the urging force of the return spring 26. As a result, the movable contact piece 8 and the movable contacts 12 and 13 move in the contact direction, and the movable contacts 12 and 13 contact the fixed contacts 10 and 11. After the movable contacts 12 and 13 contact the fixed contacts 10 and 11, the drive shaft 15 further moves in the contact direction, so that the contact spring 16 is compressed.

When the energization to the coil 21 is turned off, the movable iron core 23 and the drive shaft 15 move in the opening direction by the urging force of the return spring 26. As a result, the movable contact piece 8 and the movable contacts 12 and 13 move in the opening direction, and the movable contacts 12 and 13 are separated from the fixed contacts 10 and 11.

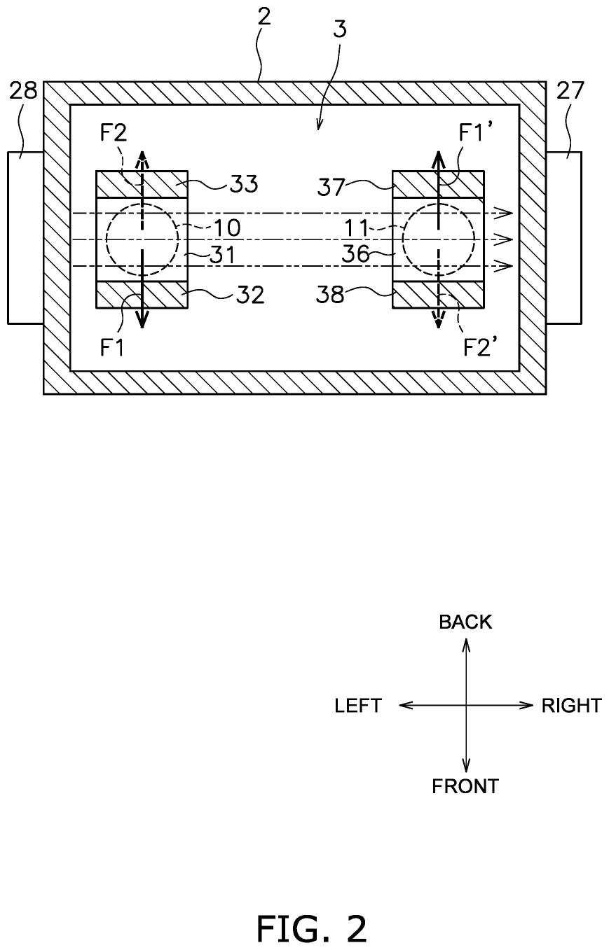

As shown in FIG. 1, the electromagnetic relay 1 includes magnets 27 and 28. The magnets 27 and 28 are permanent magnets. However, one of the magnets 27 and 28 may be a yoke. The magnets 27 and 28 are disposed around the housing 2. The magnets 27 and 28 are disposed so that the starting point of the arc generated at the contacts 10 to 13 is moved at least in a predetermined direction by a magnetic force. FIG. 2 is a sectional view taken along line II-II in FIG. 1.

As shown in FIG. 2, the magnets 27 and 28 generate a magnetic field in the housing 2. In FIG. 2, the two-dot chain arrow indicates the direction of the magnetic field. As a result, the Lorentz force acts on the arc generated at the contacts 10 to 13, and the starting point of the arc moves in the direction of the Lorentz force. Also, the arc is extended in the direction of the Lorentz force.

In FIG. 2, the solid arrows F1 and F1′indicate the direction of the Lorentz force (hereinafter referred to as “first Lorentz force”) when the current flows in the positive direction. The positive direction means a current flow from the first fixed terminal 6 to the second fixed terminal 7 via the movable contact piece 8. In FIG. 2, the broken line arrows F2 and F2′indicate the direction of the Lorentz force (hereinafter referred to as “second Lorentz force”) when the current flows in the opposite direction. The reverse direction means a current flow from the second fixed terminal 7 to the first fixed terminal 6 via the movable contact piece 8.

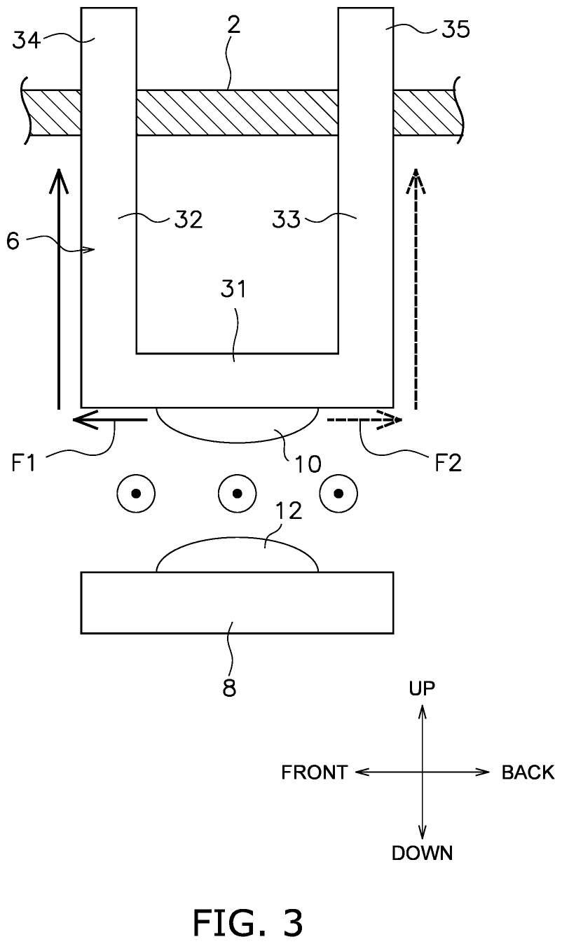

FIG. 3 is a side view of the first fixed terminal 6 and the movable contact piece 8. As shown in FIG. 3, the first fixed terminal 6 includes a contact support portion 31, a first arc guide 32, and a second arc guide 33. The contact support portion 31 has a plate-like shape. The contact support portion 31 supports the first fixed contact 10. The first fixed contact 10 is joined to the contact support portion 31 by fused bonding. For example, the first fixed contact 10 is fixed to the contact support portion 31 by brazing. Alternatively, the first fixed contact 10 may be fixed to the contact support portion 31 by welding. Alternatively, the first fixed contact 10 may be fixed to the contact support portion 31 by ultrasonic bonding.

The first arc guide 32 has a plate-like shape. The first arc guide 32 extends upward from the first contact support portion 31. The first arc guide 32 is connected to the contact support portion 31 at a position disposed in the direction of the first Lorentz force F1 with respect to the first fixed contact 10. As shown in FIG. 2, in the present embodiment, the first Lorentz force F1 is directed forward. Therefore, the first arc guide 32 is connected to the front portion of the contact support portion 31. When the current flows in the positive direction, the starting point of the arc generated at the first fixed contact 10 moves in the direction of the first Lorentz force F1 and moves along the first arc guide 32. Therefore, the first arc guide 32 is disposed in the housing 2 so as to extend the arc generated at the first fixed contact 10. The magnet 28 may be disposed so that a magnetic flux is applied to a point where the starting point of the arc is controlled. For example, the magnet 28 may be disposed in the housing 2 so as to apply the magnetic flux to the end of the first arc guide 32. Alternatively, the magnet 28 may be disposed in the housing 2 so that the magnetic flux is applied to a position below the end of the first arc guide 32.

The second arc guide 33 has a plate-like shape. The second arc guide 33 extends upward from the contact support portion 31. The second arc guide 33 is connected to the contact support portion 31 at a position disposed in the direction of the second Lorentz force F2 with respect to the first fixed contact 10. As shown in FIG. 2, in the present embodiment, the second Lorentz force F2 is directed backward. Therefore, the second arc guide 33 is connected to the rear portion of the contact support portion 31. When the current flows in the opposite direction, the starting point of the arc generated at the first fixed contact 10 moves in the direction of the second Lorentz force F2 and moves along the second arc guide 33. Therefore, the second arc guide 33 is disposed in the housing 2 so as to extend the arc generated at the first fixed contact 10. The magnet 28 may be disposed so that a magnetic flux is applied to a point where the starting point of the arc is controlled. For example, the magnet 28 may be disposed in the housing 2 so as to apply magnetic flux to the end of the second arc guide 33. Alternatively, the magnet 28 may be disposed in the housing 2 so that the magnetic flux is applied to a position below the end of the second arc guide 33.

The first fixed terminal 6 has a bent shape between the first arc guide 32 and the contact support portion 31. The first fixed terminal 6 has a bent shape between the second arc guide 33 and the contact support portion 31. Therefore, the first fixed terminal 6 has a U-shaped bent shape.

The tip 34 of the first arc guide 32 projects outward of the housing 2. The tip 35 of the second arc guide 33 projects outward of the housing 2. The tip 34 of the first arc guide 32 and the tip 35 of the second arc guide 33 are used as external terminals. That is, the tip 34 of the first arc guide 32 and the tip 35 of the second arc guide 33 are electrically connected to an external electronic circuit. For example, the tip 34 of the first arc guide 32 and the tip 35 of the second arc guide 33 are connected to a substrate. Alternatively, the tip 34 of the first arc guide 32 and the tip 35 of the second arc guide 33 may be connected to an electric wire or a bus bar.

The second fixed terminal 7 has the same shape as the first fixed terminal 6. As shown in FIG. 2, the second fixed terminal 7 includes a contact support portion 36, a first arc guide 37, and a second arc guide 38. The contact support portion 36, the first arc guide 37, and the second arc guide 38 of the second fixed terminal 7 are the same as the contact support portion 31, the first arc guide 32, and the second arc guide 33 of the first fixed terminal 6.

In the electromagnetic relay 1 according to the present embodiment described above, the arcs generated at the fixed contact 10 are extended along the first arc guide 32 or the second arc guide 33. Thereby, the arc can be extinguished quickly. Further, the tip 34 of the first arc guide 32 and the tip 35 of the second arc guide 33 project to the outside from the housing 2 and are used as external terminals. Therefore, the current flows separately in the first arc guide 32 and the second arc guide 33. Thereby, heat generation in each of the first arc guide 32 and the second arc guide 33 can be reduced. Further, the heat generated by the fixed contact 10 can be transmitted to the outside of the electromagnetic relay via a plurality of paths.

Although one embodiment of the present invention has been described above, the present invention is not limited to the above embodiment, and various modifications can be made without departing from the gist of the invention. The configuration of the contact device is not limited to that of the above embodiment, and may be changed.

For example, the shape of the movable contact piece 8 may be changed. The first movable contact 12 and the second movable contact 13 may be integrated with the movable contact piece 8. The first fixed contact 10 may be integrated with the first fixed terminal 6. The second fixed contact 11 may be integrated with the second fixed terminal 7. The number of movable contacts is not limited to two, and may be more than two. The number of fixed contacts is not limited to two, and may be more than two. The configuration of the movable mechanism 9 is not limited to that of the above embodiment, and may be changed. The configuration of the drive device 4 is not limited to that of the above embodiment, and may be changed.

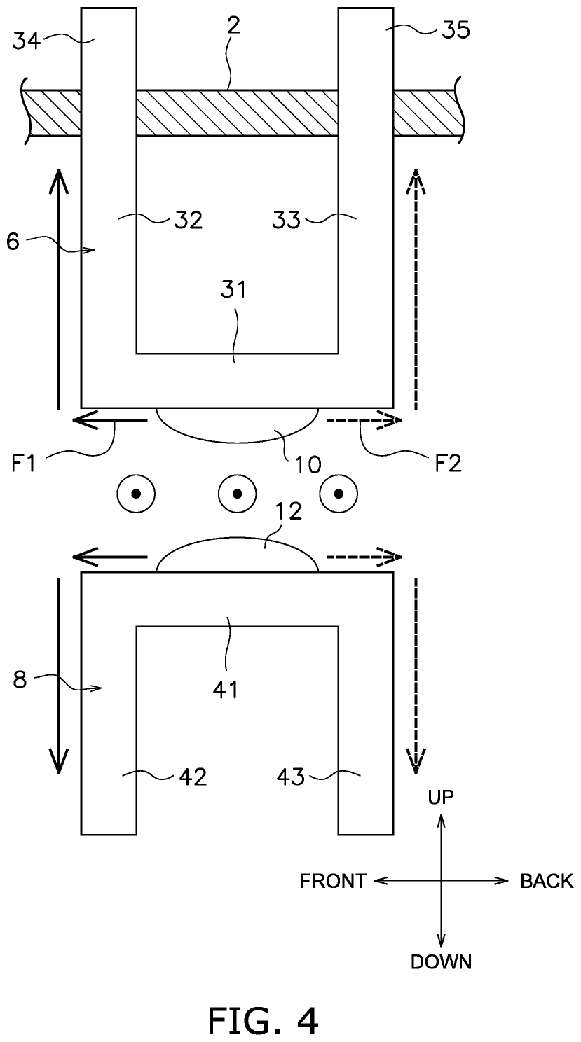

FIG. 4 is a side view of the first fixed terminal 6 and the movable contact piece 8 according to the first modification. As shown in FIG. 4, the movable contact piece 8 may include a contact piece body 41 and arc guides 42 and 43. The arc guide 42 is connected to the contact piece body 41 at a position disposed in the direction of the first Lorentz force Fl with respect to the first movable contact 12. The arc guide 43 is connected to the contact piece body 41 at a position disposed in the direction of the second Lorentz force F2 with respect to the first movable contact 12.

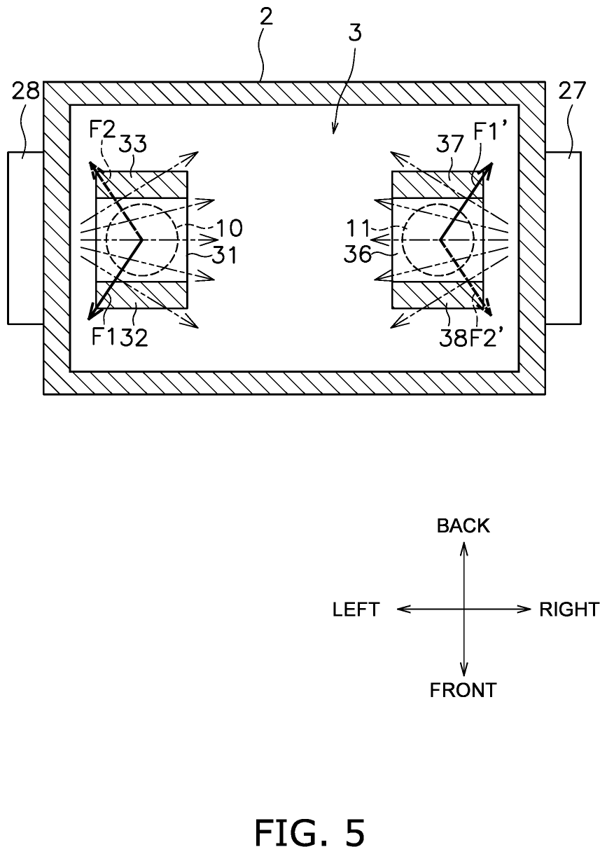

The arrangement of the magnets 27 and 28 or the arrangement of the magnetic field by the magnets 27 and 28 may be changed. For example, FIG. 5 is a top view of the contact device 3 according to the second modification. In FIG. 5, the dashed arrow indicates the direction of the magnetic field. As shown in FIG. 5, the magnets 27 and 28 may be disposed so that the magnetic field extends radially from the magnets 27 and 28. In this case, the directions of the first Lorentz force F1 and F1′and the directions of the second Lorentz force F2 and F2′ may be a direction inclined with respect to the front-rear direction and the left-right direction. In this case, the first arc guide 32 and the second arc guide 33 may be connected to the front portion and the rear portion of the contact support portion 31, respectively.

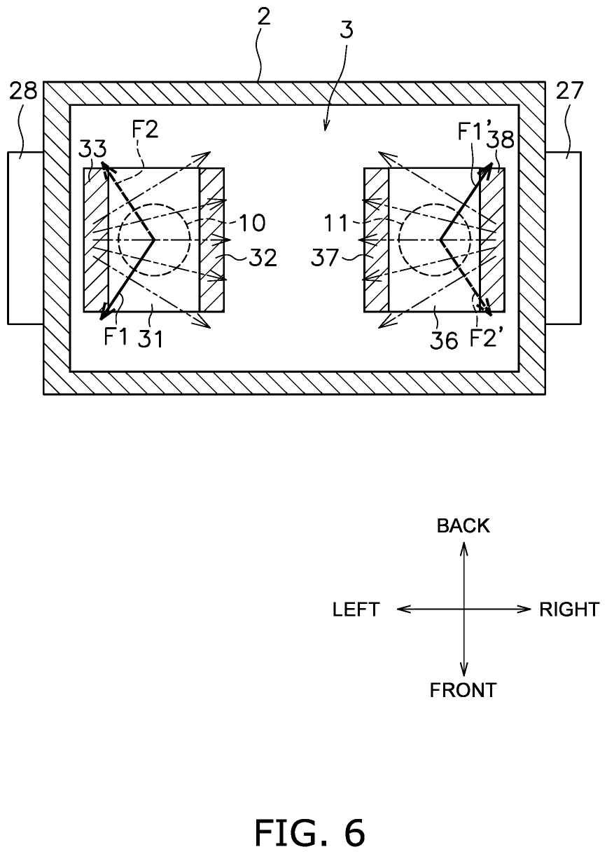

Alternatively, the arrangement of the first arc guide 32 and the second arc guide 33 may be changed. For example, FIG. 6 is a top view of the contact device 3 according to the third modification. As shown in FIG. 6, the first arc guide 32 and the second arc guide 33 may be connected to the left and right side portions of the contact support portion 31, respectively.

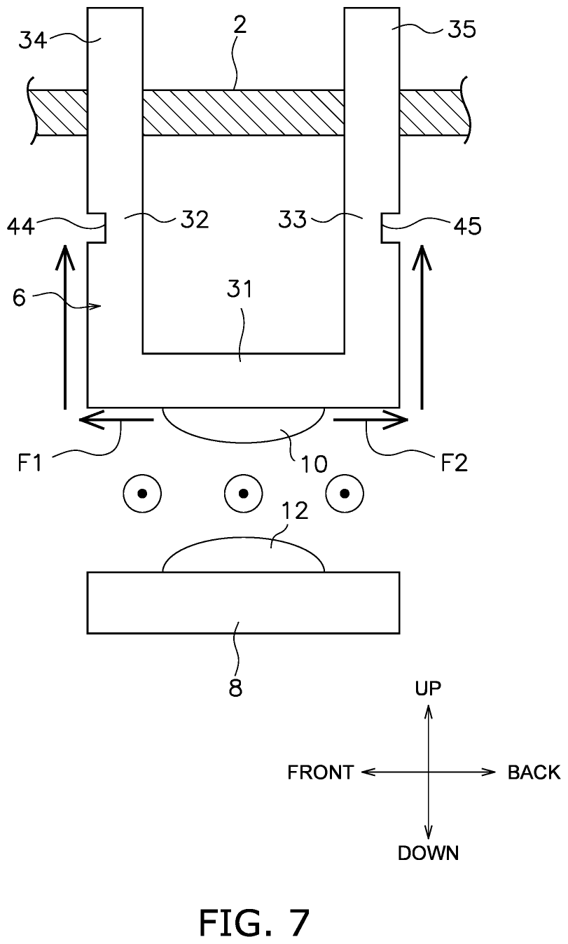

The shapes of the first arc guide 32 and the second arc guide 33 may be changed. The first arc guide 32 and the second arc guide 33 may include a step portion disposed in the housing 2. For example, FIG. 7 is a side view of the first fixed terminal 6 and the movable contact piece 8 according to the fourth modification. As shown in FIG. 7, the first arc guide 32 includes a first step portion 44. The first step portion 44 is provided on the surface of the first arc guide 32 disposed in the direction of the first Lorentz force F1. The second arc guide 33 includes a second step portion 45. The second step portion 45 is provided on the surface of the second arc guide 33 disposed in the direction of the second Lorentz force F2. In the fourth modification, the first step portion 44 and the second step portion 45 are recesses.

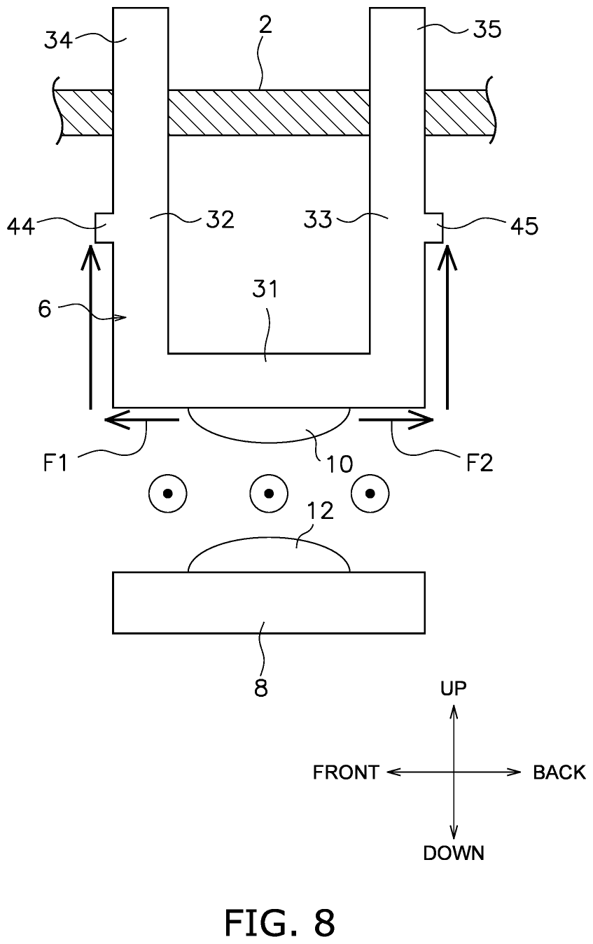

FIG. 8 is a side view of the first fixed terminal 6 and the movable contact piece 8 according to the fifth modification. As shown in FIG. 8, the first step portion 44 and the second step portion 45 may be protrusions. Alternatively, the first step portion 44 and the second step portion 45 may be holes. The first step portion 44 and the second step portion 45 can regulate the movement of the starting point of the arc along the first arc guide 32 or the second arc guide 33.

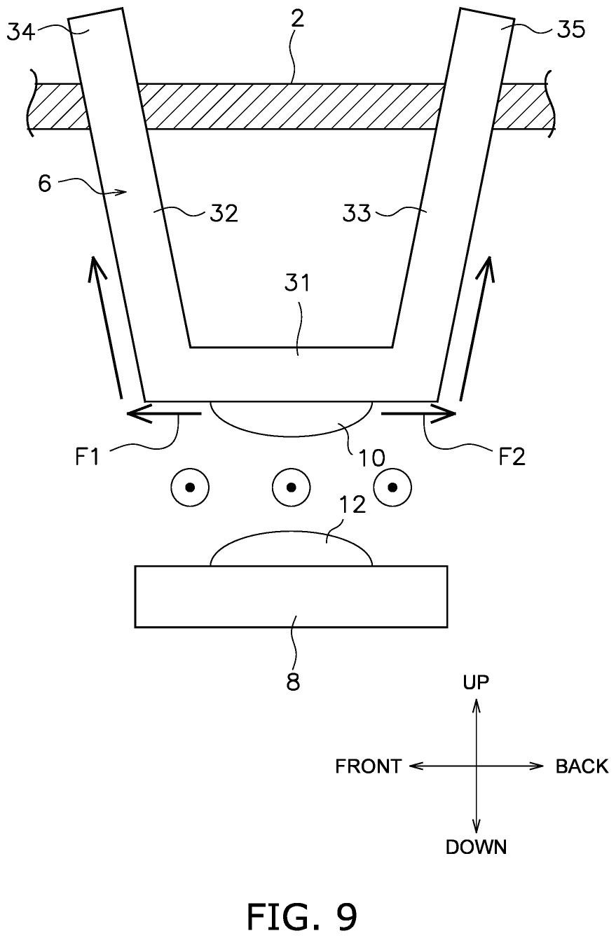

The first arc guide 32 and the second arc guide 33 may be disposed so as to be inclined with respect to the vertical direction. For example, FIG. 9 is a side view of the first fixed terminal 6 and the movable contact piece 8 according to the sixth modification. As shown in FIG. 9, the first arc guide 32 and the second arc guide 33 are inclined so that the distance between them increases toward the direction away from the first fixed contact 10. That is, the first arc guide 32 and the second arc guide 33 are inclined so that the distance between them increases in the direction in which the arc is extended. Thereby, the movement of the starting point of the arc along the first arc guide 32 or the second arc guide 33 can be controlled.

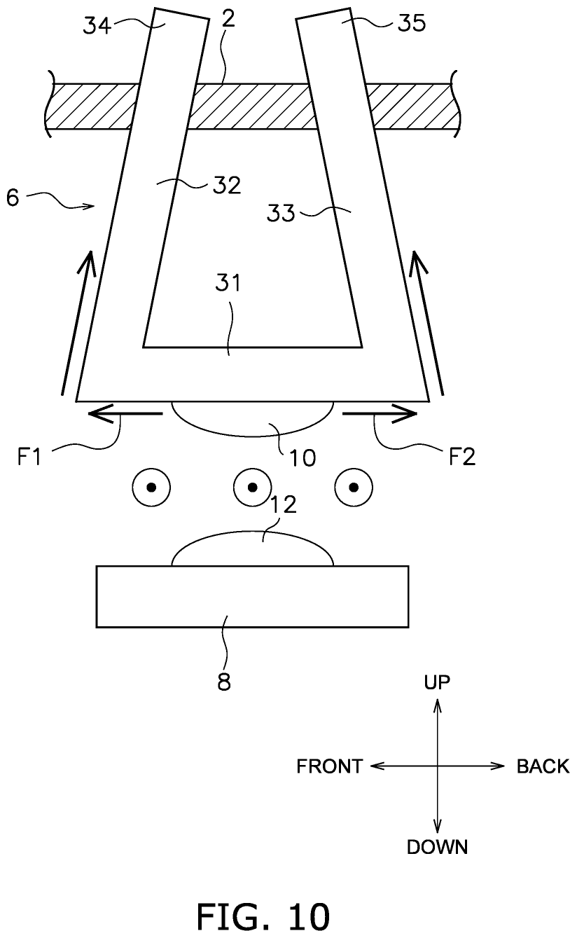

FIG. 10 is a side view of the first fixed terminal 6 and the movable contact piece 8 according to the seventh modification. As shown in FIG. 10, the first arc guide 32 and the second arc guide 33 are inclined so that the distance between them becomes smaller toward the direction away from the first fixed contact 10. That is, the first arc guide 32 and the second arc guide 33 are inclined so that the distance between them becomes smaller in the direction in which the arc is extended. Thereby, the movement of the starting point of the arc along the first arc guide 32 or the second arc guide 33 can be controlled.

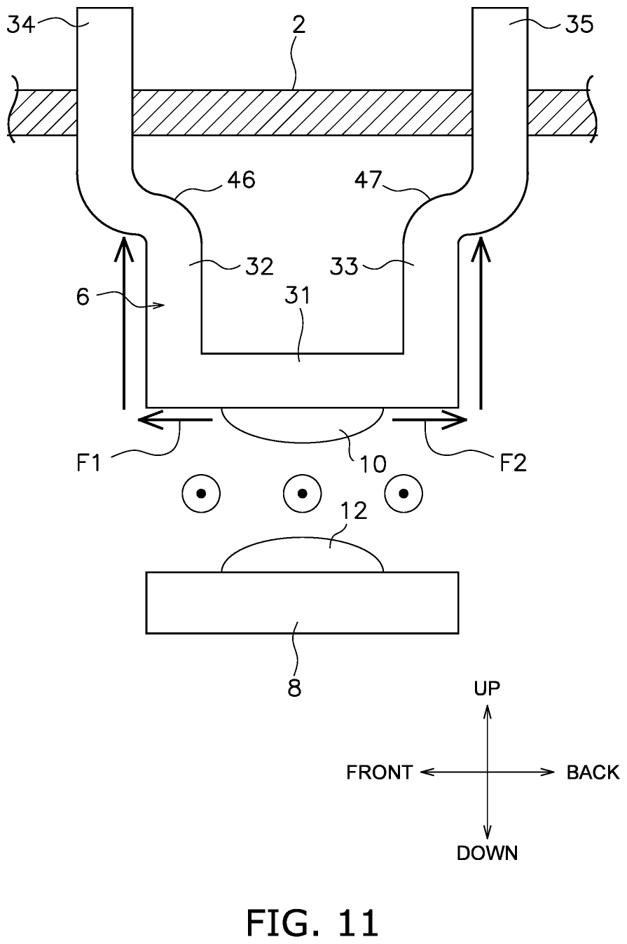

The first arc guide 32 and the second arc guide 33 may include a bent portion. For example, FIG. 11 is a side view of the first fixed terminal 6 and the movable contact piece 8 according to the eighth modification. As shown in FIG. 11, the first arc guide 32 includes a first bent portion 46. The second arc guide 33 includes a second bent portion 47. The first arc guide 32 and the second arc guide 33 are bent so that the distance between them increases toward the direction away from the first fixed contact 10. Thereby, the movement of the starting point of the arc along the first arc guide 32 or the second arc guide 33 can be controlled.

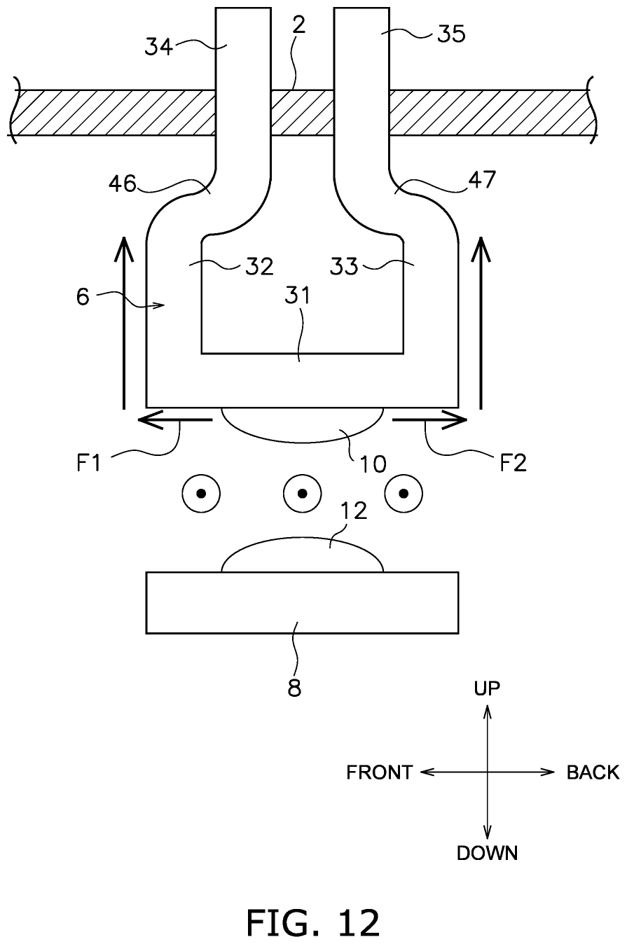

FIG. 12 is a side view of the first fixed terminal 6 and the movable contact piece 8 according to the ninth modification. As shown in FIG. 12, the first arc guide 32 and the second arc guide 33 are bent so that the distance between them becomes smaller in the direction away from the first fixed contact 10. Thereby, the movement of the starting point of the arc along the first arc guide 32 or the second arc guide 33 can be controlled.

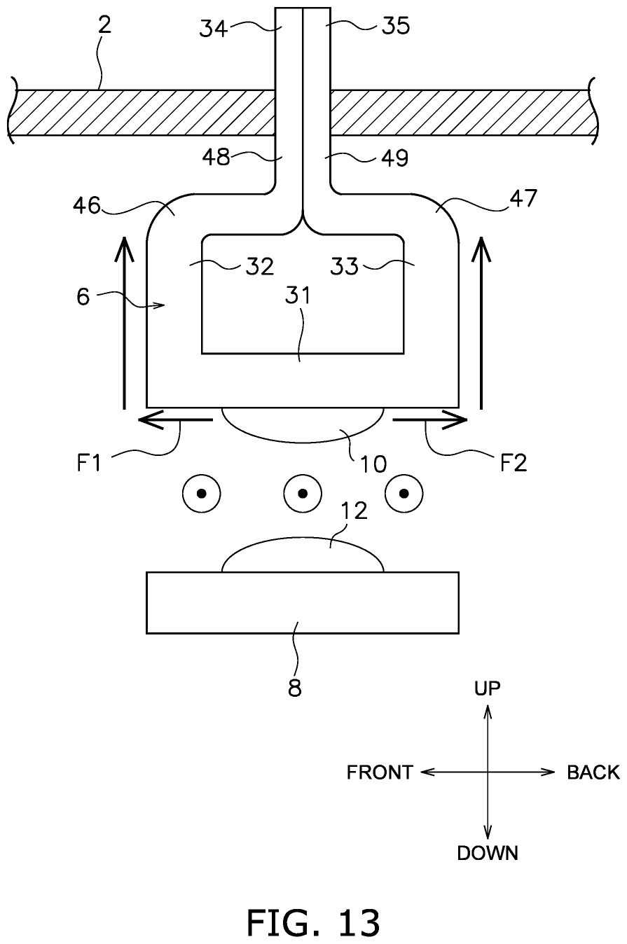

The first arc guide 32 and the second arc guide 33 may be joined to each other at least outside of the housing 2. FIG. 13 is a side view of the first fixed terminal 6 and the movable contact piece 8 according to the tenth modification. As shown in FIG. 13, the tip 34 of the first arc guide 32 and the tip 35 of the second arc guide 33 are joined to each other. The first arc guide 32 and the second arc guide 33 are bent so that the distance between them becomes smaller in the direction away from the first fixed contact 10. The first arc guide 32 includes a first joint portion 48. The first joint portion 48 includes the tip 34 of the first arc guide 32. The first joint portion 48 is disposed on the distal end side of the first bent portion 46. The second arc guide 33 includes a second joint portion 49. The second joint portion 49 includes the tip 35 of the second arc guide 33. The second joint portion 49 is disposed on the distal end side of the second bent portion 47. The first joint portion 48 and the second joint portion 49 are joined to each other. This facilitates the connection of the first fixed terminal 6 to an external electronic component.

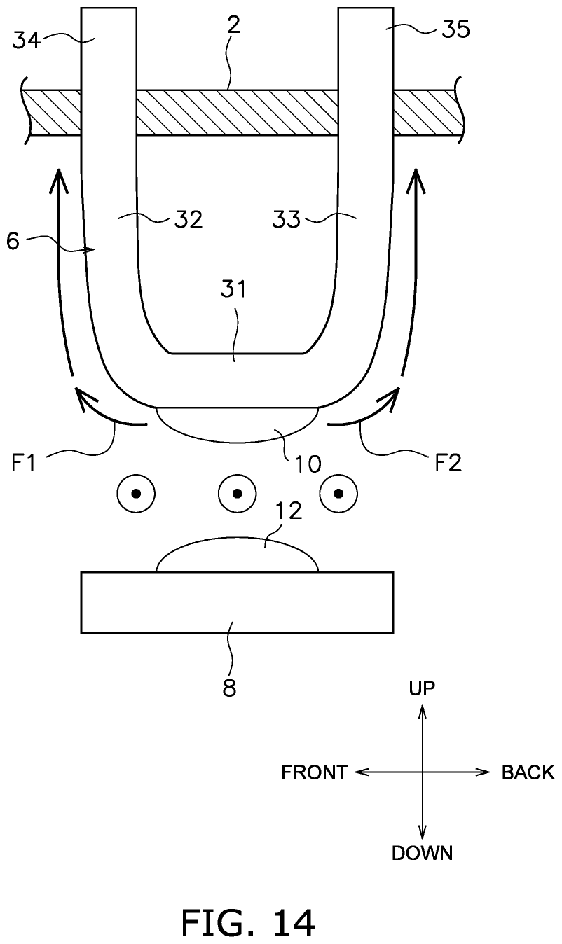

FIG. 14 is a side view of the first fixed terminal 6 and the movable contact piece 8 according to the eleventh modification. As shown in FIG. 14, the first arc guide 32 and the second arc guide 33 may have a gently curved shape. Thereby, it is possible to prevent the starting point of the arc from sticking at the corner of the first fixed terminal 6.

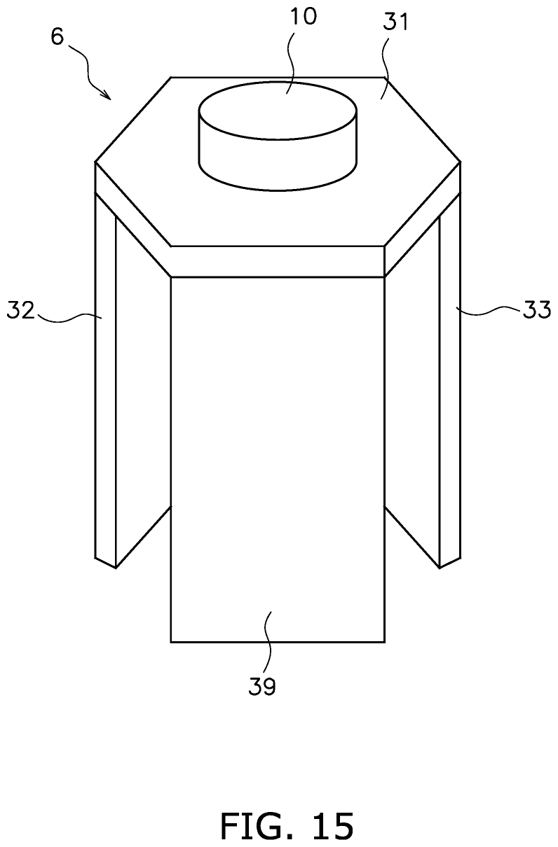

The number of arc guides of the first fixed terminal 6 is not limited to two. The number of arc guides of the first fixed terminal 6 may be one or more than two. For example, FIG. 15 is a perspective view of the first fixed terminal 6 according to the twelfth modification. As shown in FIG. 15, the number of arc guides of the first fixed terminal 6 may be three. That is, the first fixed terminal 6 may include a first arc guide 32, a second arc guide 33, and a third arc guide 39. In this case, two of the first to third arc guides 32, 33, and 39 may have both a function of extending the arc and a function of energizing. The remaining one of the first to third arc guides 32, 33, and 39 may have a function of assisting energization. Alternatively, the number of arc guides of the first fixed terminal 6 may be more than three.

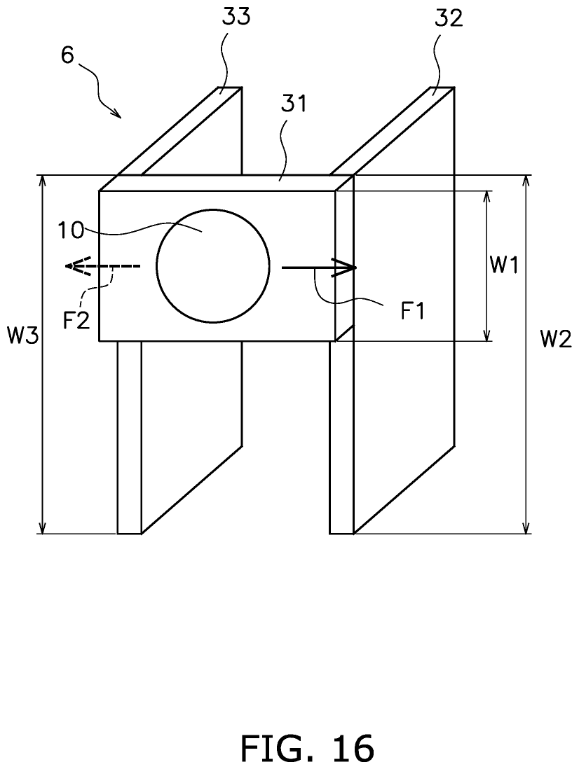

The width of the arc guide may be different from the width of the contact support portion 31. The width means a dimension in the direction perpendicular to the direction in which the starting point of the arc moves in the first fixed terminal 6. For example, FIG. 16 is a perspective view of the first fixed terminal 6 according to the thirteenth modification. As shown in FIG. 16, the width W2 of the first arc guide 32 is larger than the width W1 of the contact support portion 31. The width W3 of the second arc guide 33 is larger than the width W1 of the contact support portion 31. As a result, the heat transfer property in the first arc guide 32 and the second arc guide 33 is improved.

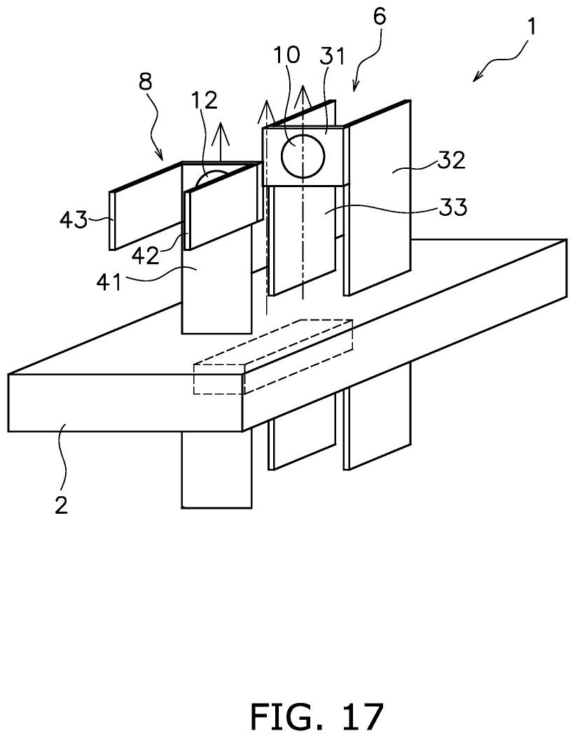

The electromagnetic relay 1 according to the above embodiment is a so-called plunger type electromagnetic relay. However, the electromagnetic relay 1 may be of another type. For example, FIG. 17 is a perspective view of a part of the electromagnetic relay 1 according to the fourteenth modification. The electromagnetic relay 1 according to the fourteenth modification is a so-called hinge type electromagnetic relay. In the hinge type electromagnetic relay 1, when the movable contact piece 8 is pushed by a drive device (not shown), the movable contact piece 8 is elastically deformed so that the movable contact 12 approaches the fixed contact 10. As a result, the movable contact 12 contacts the fixed contact 10. Further, when the pressing by the driving device is released, the movable contact piece 8 returns to the original position. As a result, the movable contact 12 is separated from the fixed contact 10.

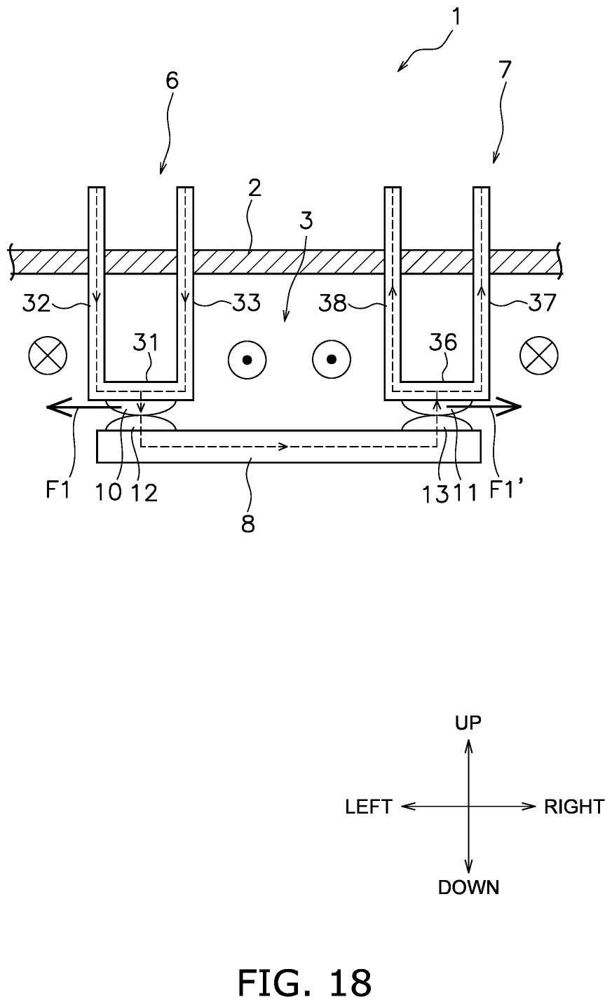

The magnets 27 and 28 described above may be omitted. In that case, the starting point of the arc generated at the first fixed contact 10 is moved by the self-magnetic field generated from the current flowing through the first fixed contact 10. For example, FIG. 18 is a front view showing a part of the electromagnetic relay 1 according to the fifteenth modification. The electromagnetic relay 1 according to the fifteenth modification is a plunger type electromagnetic relay and does not include magnets 27 and 28. As shown in FIG. 18, the magnetic flux density is high in the space inside the first fixed terminal 6 and the second fixed terminal 7. The magnetic flux density is low in the space outside the first fixed terminal 6 and the second fixed terminal 7. Therefore, the starting point of the arc moves outward in the left-right direction.

In the fifteenth modification, the first arc guide 32 is connected to the contact support portion 31 at a position outward of the first fixed contact 10 in the left-right direction. The second arc guide 33 is connected to the contact support portion 31 at a position inward of the first fixed contact 10 in the left-right direction. Therefore, the first arc guide 32 has both a function of extending an arc and a function of energizing. The second arc guide 33 has a function of energizing.

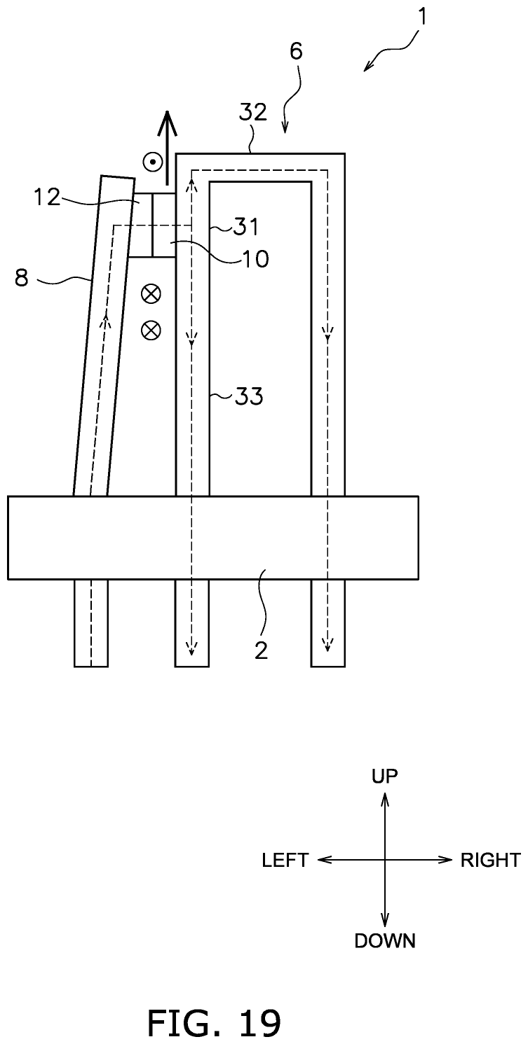

FIG. 19 is a front view showing a part of the electromagnetic relay 1 according to the sixteenth modification. The electromagnetic relay 1 according to the sixteenth modification is a hinge type electromagnetic relay and does not include magnets 27 and 28. As shown in FIG. 19, the magnetic flux density is high in the space inside the movable contact piece 8 and the fixed terminal 6. The magnetic flux density is low in the space outside the movable contact piece 8 and the fixed terminal 6. Therefore, the starting point of the arc moves upward.

In the sixteenth modification, the first arc guide 32 is connected to the contact support portion 31 at a position above the fixed contact 10. The second arc guide 33 is connected to the contact support portion 31 at a position below the fixed contact 10. Therefore, the first arc guide 32 has both a function of extending an arc and a function of energizing. The second arc guide 33 has a function of energizing.

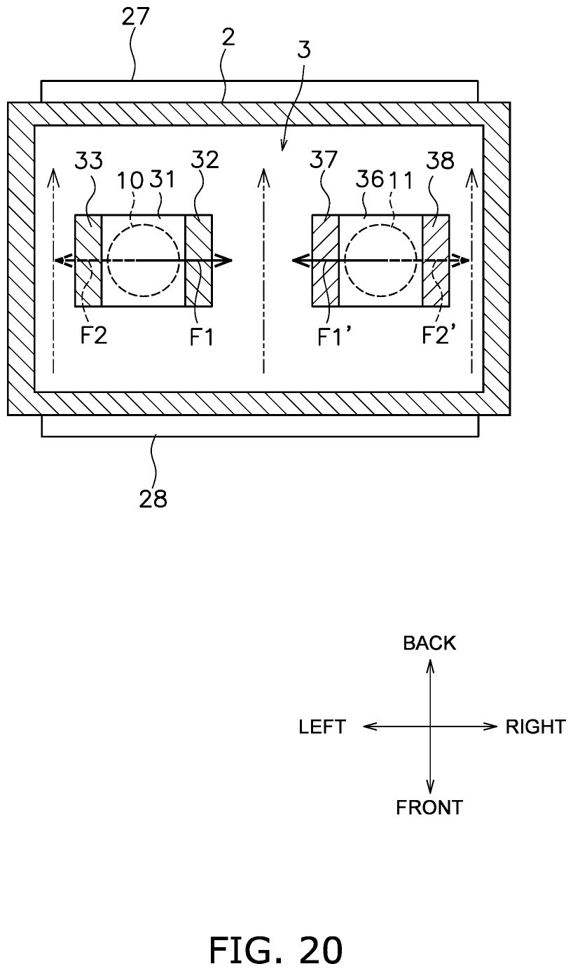

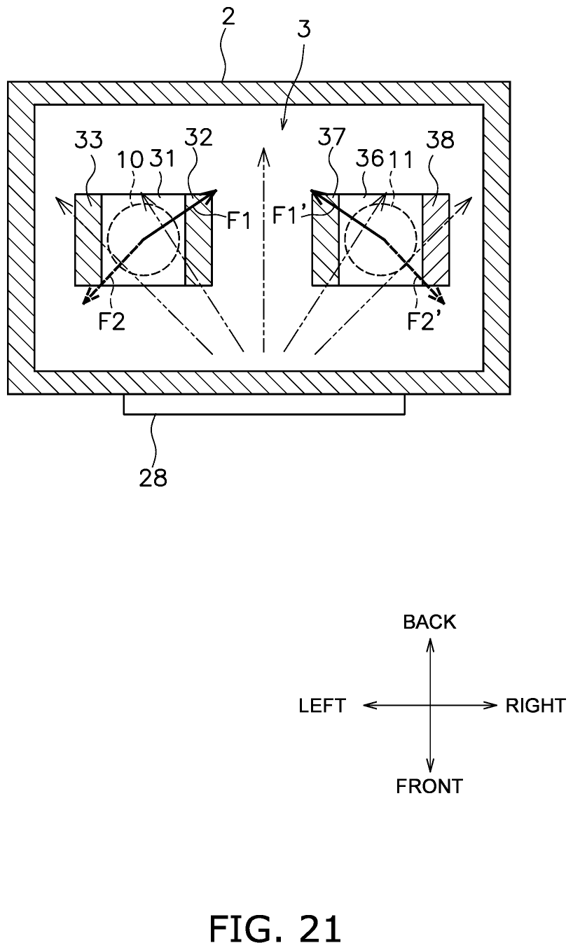

In the above embodiment, the magnets 27 and 28 are disposed in the left-right direction with respect to the contacts 10 to 13. However, as in the seventeenth modification shown in FIG. 20, the magnets 27 and 28 may be disposed in the front-rear direction with respect to the contacts 10 to 13. Alternatively, as in the eighteenth modification shown in FIG. 21, the magnet 28 may be disposed in only one of the front-rear directions with respect to the contact points 10 to 13.

### REFERENCE SIGNS LIST

2 Housing

6 First fixed terminal

10 First fixed contact

12 First movable contact

28 magnet

31 Contact support portion

32 First arc guide

33 Second arc guide

44 First step portion

1. An electromagnetic relay comprising:
a housing;
a fixed contact disposed in the housing;
a movable contact disposed in the housing, the movable contact facing the fixed contact; and
a fixed terminal to which the fixed contact is connected, the fixed terminal including
a contact support portion supporting the fixed contact,
a first arc guide extending from the contact support portion, the first arc guide being disposed in the housing to extend an arc generated at the fixed contact, the first arc guide including a first tip protruding outward of the housing, and
a second arc guide extending from the contact support portion, the second arc guide being disposed in the housing to extend the arc generated at the fixed contact, the second arc guide including a second tip protruding outward of the housing.

2. The electromagnetic relay according to claim 1, further comprising:
a magnet disposed so that a starting point of the arc generated at the fixed contact is moved at least in a predetermined direction by a magnetic force, wherein
the first arc guide is connected to the contact support portion at a first position in the predetermined direction with respect to the fixed contact, and
the second arc guide is connected to the contact support portion at a second position in an opposite direction to the predetermined direction with respect to the fixed contact.

3. The electromagnetic relay according to claim 1, wherein
the starting point of the arc generated at the fixed contact is moved at least in a predetermined direction by a self-magnetic field generated from a current flowing through the fixed contact,
the first arc guide is connected to the contact support portion at a first position in the predetermined direction with respect to the fixed contact, and
the second arc guide is connected to the contact support portion at a second position in an opposite direction to the predetermined direction with respect to the fixed contact.

4. The electromagnetic relay according to claim 1, wherein
the fixed terminal has a bent shape between the first arc guide and the contact support portion.

5. The electromagnetic relay according to claim 1, wherein
the fixed terminal has a bent shape between the second arc guide and the contact support portion.

6. The electromagnetic relay according to claim 1, wherein
the fixed contact is joined to the contact support portion by fused bonding.

7. The electromagnetic relay according to claim 1, wherein
the first arc guide and the second arc guide are joined to each other at least outside of the housing.

8. The electromagnetic relay according to claim 1, wherein
the first arc guide and the second arc guide are inclined so that a distance between the first arc guide and the second arc guide increases toward a direction away from the fixed contact.

9. The electromagnetic relay according to claim 1, wherein
the first arc guide and the second arc guide are inclined so that a distance between the first arc guide and the second arc guide becomes smaller toward a direction away from the fixed contact.

10. The electromagnetic relay according to claim 1, wherein
the first arc guide includes a step portion disposed in the housing.
